(19) United States
(12) Patent Application Publication
(10) Pub. No.: US 2002/0149206 A1
(43) Pub. Date: Oct. 17, 2002

(54) Continuous power supply with back-up generation

(76) Inventors: Mark G. Gilbreth, Simi Valley, CA (US); Everett Geis, Orange, CA (US); Claude Khalizadeh, San Ramon, CA (US); David McShane, Oak Park, CA (US); Joel Wacknov, Thousand Oaks, CA (US); Simon Wall, Thousand Oaks, CA (US)

Correspondence Address: IRELL & MANELLA LLP, Suite 900, 1800 Avenue of the Stars, Los Angeles, CA, 90067, US

(21) Appl. No.: 10/072,501

(22) Filed: Feb. 5, 2002

Related U.S. Application Data
(60) Provisional application No. 60/266,639, filed on Feb. 5, 2001.
(60) Provisional application No. 60/270,354, filed on Feb. 21, 2001.
(60) Provisional application No. 60/276,352, filed on Mar. 16, 2001.

(51) Int. Cl. F02C 6/00; H02K 7/18; H02P 9/04; F01D 15/10

(52) U.S. Cl. 290/52

(57) ABSTRACT

A continuous power supply may include a turbogenerator to provide power to supply the load and or an energy storage element and possibly also to the primary energy source. Utilizing an isolated DC bus architecture permits bi-directional power flow among interconnected elements.

### RELATED APPLICATIONS

This application claims the priority of U.S. provisional patent application Serial No. 60/266,639 filed Feb. 5, 2001, and U.S. provisional patent application Serial No. 60/270,354 filed Feb. 21, 2001, and U.S. provisional patent application Serial No. 60/276,352 filed Mar. 16, 2001.

### BACKGROUND OF THE INVENTION

1. Field of the Invention

This invention relates to continuous power systems, and more specifically to continuous power systems with back-up generation.

2. Description of the Prior Art

What is needed is a turbogenerator based power supply with backup generation or an uninterruptable power supply.

### SUMMARY OF THE INVENTION

In a first aspect, the present invention provides a power supply with back-up generation including a power source connected to a first bi-directional converter, a turbogenerator generator connected to a second bi-directional converter, a load connected to a converter, a DC bus interconnecting each of the converters, an energy storage element connected to the DC bus, a bus sensor element connected to the DC bus, and a supervisory control receiving bus sensor signals for controlling the turbogenerator.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

### DETAILED DESCRIPTION OF THE PREFERRED EMBODIMENT(S)

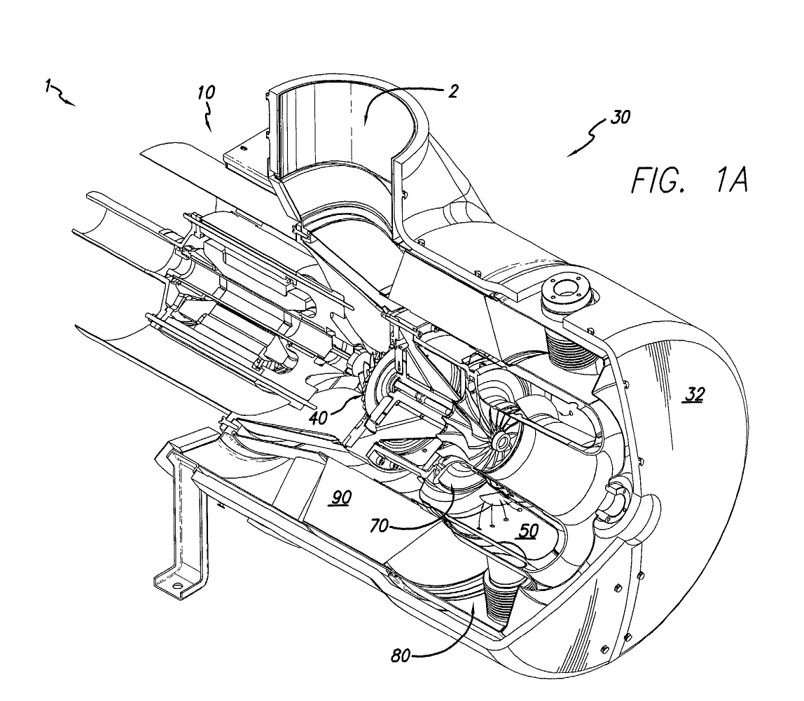

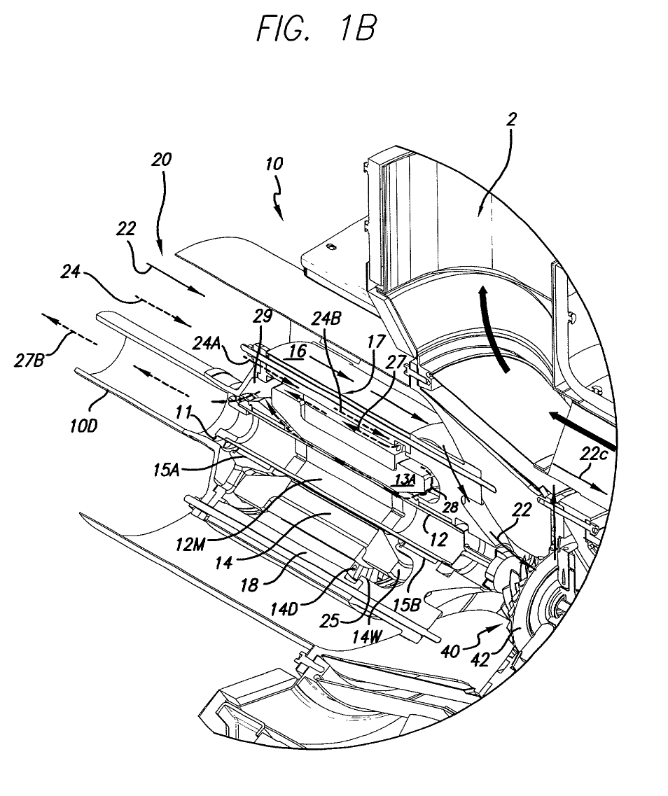

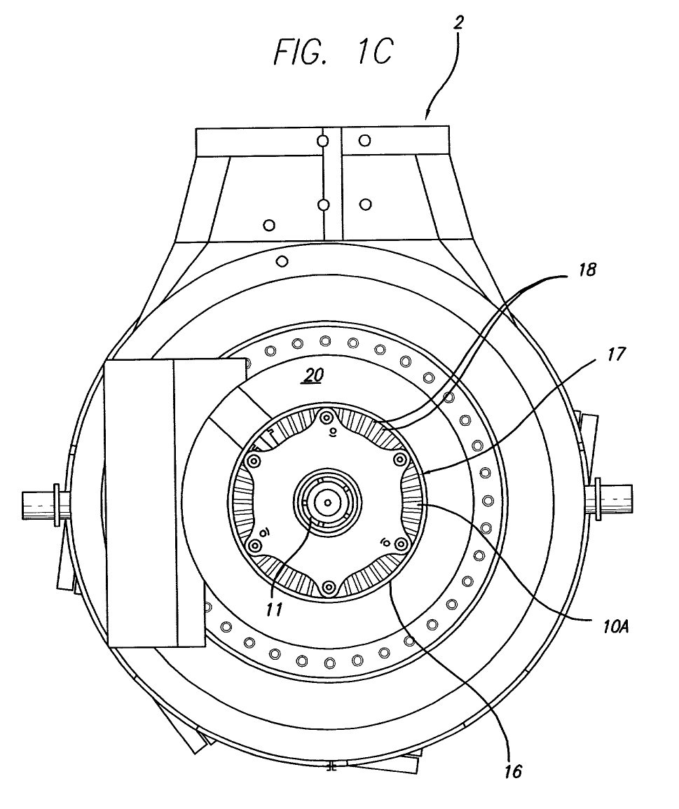

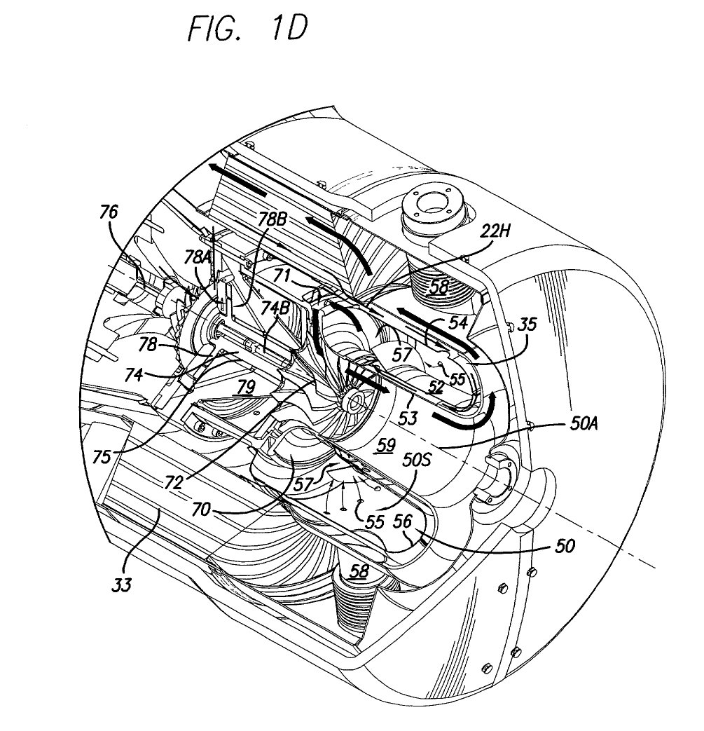

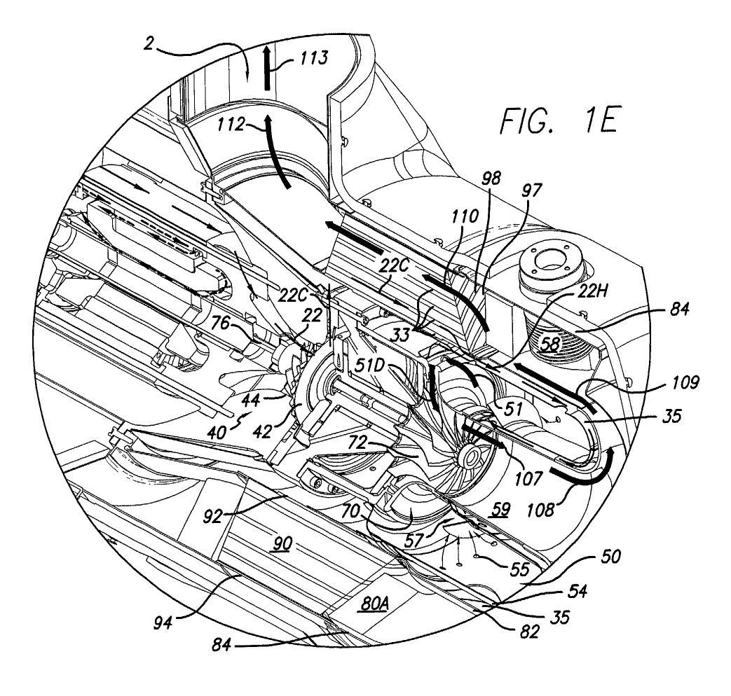

With reference to FIG. 1A, an integrated turbogenerator 1 according to the present disclosure generally includes motor/generator section 10 and compressor-turbine section 30. Compressor-turbine section 30 includes exterior can 32, compressor 40, combustor 50 and turbine 70. A recuperator 90 may be optionally included.

Referring now to FIG. 1B and FIG. 1C, in a currently preferred embodiment of the present disclosure, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

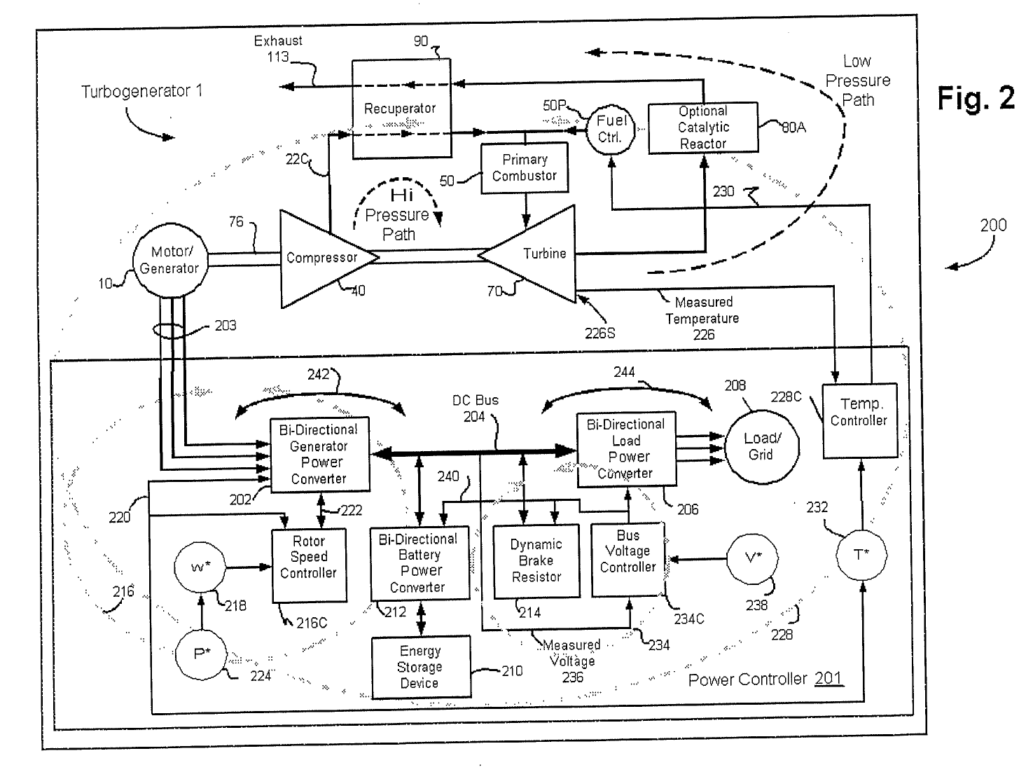

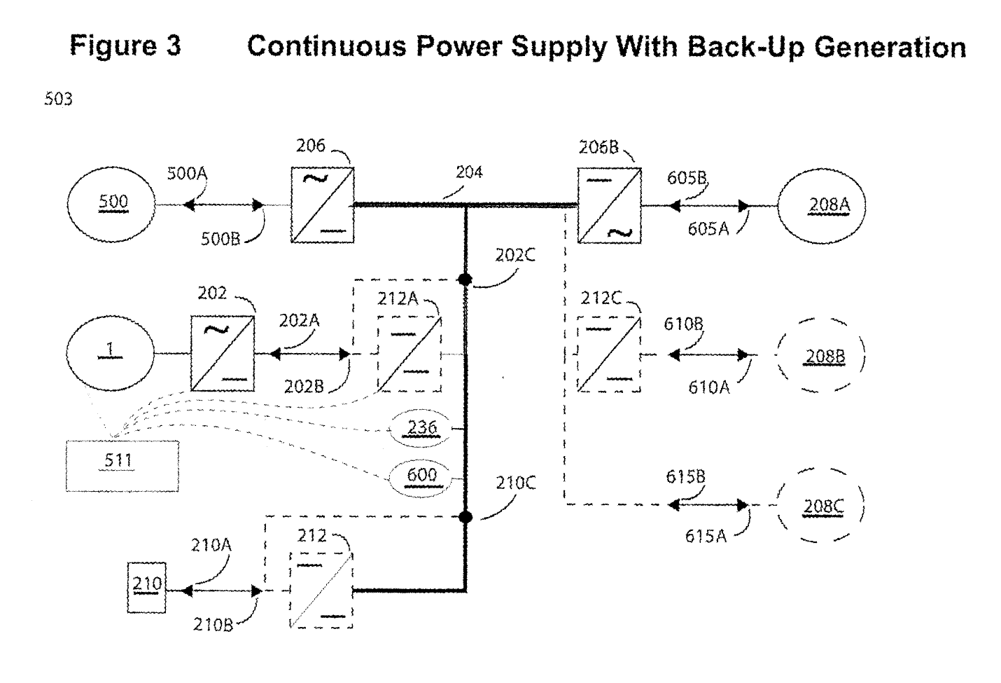

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 50A. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 74 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 51D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 97 of recuperator 90, as indicated by gas flow arrows 108 and 109 respectively.

In an alternate embodiment of the present disclosure, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Embodiments of an Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In still another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

An integrated turbogenerator is a turbogenerator in which the turbine, compressor, and generator are all constrained to rotate based upon rotation of the shaft to which the turbine is connected. The methods and apparatus disclosed herein are preferably but not necessarily used in connection with a turbogenerator, and preferably but not necessarily used in connection with an integrated turbogenerator.

Control System

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bi-directional arrow 244, (2) applying or removing power from energy storage device 210 under the control of battery power converter 212, and (3) by removing power from DC bus 204 by modulating the connection of dynamic brake resistor 214 to DC bus 204.

The method and apparatus disclosed above contain elements interchangeable with elements of the methods and apparatus below.

Referring now to FIG. 3, power supply 503 is shown combining power source 500 with turbogenerator 1. Power source 500 is connected to bi-directional load power converter 206 that is connected to DC bus 204. Power Source 500 may be a utility grid, a local power network, or another power distribution, power storage, or power generation system. Bi-directional converter 206 enables power source 500 to either supply power 500B to, or to consume power 500A from DC bus 204.

FIG. 3 also shows turbogenerator 1 connected to bi-directional generator power converter 202 that is connected to bi-directional power converter 212A that is connected to DC bus 204. Bi-directional converters 202 and 212A enable turbogenerator 1 to either supply power 202B to, or to consume power 202A from, DC bus 204. Converter 202 may be connected directly to DC bus 204 if converter 202 is designed to operate within the range of DC bus voltages 236 present on DC bus 204. Direct connection 202C of converter 202 to DC bus 204 would eliminate the need for converter 212A.

FIG. 3 also shows AC load 208A connected to converter 206B that is connected to DC bus 204. Load 208A may consume power, indicated by flow arrow 605A, from DC bus 204. In the alternative, converter 206B may be a bi-directional converter and load 208A may supply power 605B to DC bus 204.

FIG. 3 also shows DC load 208B on DC bus 204. Load 208B is connected to converter 212C that is connected to DC bus 204. Load 208B may consume power610A from DC bus 204. In the alternative, converter 212C may be a bi-directional converter and Load 208B may supply power 610B to DC bus 204.

FIG. 3 also shows DC load 208C on DC bus 204. Load 208C is connected to DC bus 204. Load 208C may consume power 615A from DC bus 204. In the alternative, load 208C may supply power 615B to DC bus 204.

FIG. 3 also shows energy storage 210 connected to bi-directional battery power converter 212 that is connected to DC bus 204. Bi-directional converter 212 enables energy storage 210 to supply power 210B to the DC bus 204, or to consume power 210A from the DC bus 204. Energy storage 210 may be connected directly to the DC bus 204 if energy storage 210 is designed to operate within the range of DC bus voltages 236 present on DC bus 204. The direct connection 210C of energy storage 210 to DC bus 204 would eliminate the need for converter 212A.

FIG. 3 also shows bus sensor 600 connected to DC bus 204 between DC bus connection 210C and DC bus voltage measurement 236. Bus sensor 600 may be used to measure bus status including the flow of power 210A to, and the flow of power 210B from, energy storage 210.

FIG. 3 also shows supervisory controller 511. Controller 511 may be comprised of a plurality of processing elements. Controller 511 may have connections to bus sensor 600, voltage sensor 236, turbogenerator 1, converter 202, and converter 212A. Controller 511 may also include functions comprising turbogenerator start, operation, stop, fault, and reporting/diagnostics.

In a currently preferred embodiment, converter 202 and energy storage 210 may be connected directly to the DC bus. In a second embodiment, converter 202 may be connected directly to the DC bus and energy storage 210 may be connected to converter 212. In a third embodiment, energy storage 210 may be connected directly to the DC bus and converter 202 may be connected to converter 212A.

In a first mode of operation, power source 500 supplies power 500Bto DC bus 204, enabling DC bus voltage 236 to be controlled within a prescribed range. If power source 500 is unable to supply sufficient power to the DC bus 204 to maintain DC bus voltage 236, then DC bus 204 draws power 210B from energy storage 210. Bus sensor 600 senses the flow of power 210B from energy storage. Supervisory controller 511 starts turbogenerator 1 when flow of power 210B from energy storage 210 exceeds prescribed limits. Turbogenerator 1 consumes power 202A, from DC bus 204 during start. After reaching self-sustaining speed, turbogenerator 1 supplies power 202B to DC Bus 204 and power exchange between DC bus 204 and energy storage 210 reverses as energy storage 210 is recharged by the flow of power 210A from DC bus 204.

In a second mode of operation, turbogenerator 1 may be supplying power 202B to the DC bus 204. Load 208 may be consuming power 605A from DC bus 204 and power supply 500 may be consuming power 500A from DC bus 204.

In a third mode of operation, one or more of loads 208 may be supplying power to the DC bus as indicated by one or more of power arrows 605B, 610B, and or 615B respectively.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A power supply with back-up generation comprising:
a power source connected to a first bi-directional converter;
a turbogenerator generator connected to a second bi-directional converter;
a load connected to a converter;
a DC bus interconnecting each of the converters;
an energy storage element connected to the DC bus;
a bus sensor element connected to the DC bus, providing bus status signals; and
a controller receiving bus status signals for controlling turbogenerator.

2. The power supply of claim 1 wherein the bus status signals further comprise:
DC bus voltage; and
energy storage element current flow.

3. The power supply of claim 1 wherein the controller further comprises:
a decoupled speed control loop;
a decoupled temperature control loop; and
a decoupled power control loop.

4. A method of providing uninterruptable power to a load comprising:
providing a primary power source isolated by a first bi-directional power converter;
providing a turbogenerator isolated by a second bi-directional power converter;
providing a load isolated by a power converter;
interconnecting each of the isolation power converters with a DC bus;
connecting an energy storage element to the DC bus;
monitoring the status of the DC bus and providing the status signals to the controller; and
controlling the turbogenerator using bus status signals.
